(19) United States
(12) Patent Application Publication
(10) Pub. No.: US 2007/0299678 A1
(43) Pub. Date: Dec. 27, 2007

(54) Community value calculation method and community value calculation system

(76) Inventor: Kunihiko Kido, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/505,319

(22) Filed: Aug. 17, 2006

(30) Foreign Application Priority Data
May 11, 2006 (JP) 2006-132396

(51) Int. Cl. G06Q 10/00; G07G 1/00; G06Q 30/00; G06F 17/30

(52) U.S. Cl. 705/1; 705/10

(57) ABSTRACT

With respect to social capital, since no market exists to deal with the social capital itself, financial evaluation based on cash flow cannot be performed.

Profiles are created according to service attributes of services in a community. Then, members in a regional society are requested to selects one of the profiles and a questionnaire survey is conducted concerning actual situations of services in a community. Social capital indices are computed based on data collected in the survey, willingness to pay (WTP) is estimated for each service of the community in the regional society based on the social capital indices and the questionnaire data. Thereafter, to calculate a community value, one of the service attributes is designated and a difference among calculated marginal WTP values of some regional societies is evaluated as a financial value of social capital.

### CLAIMS OF PRIORITY

The present application claims prority from Japanese application serial no. JP 2006-132396, filed on May 11, 2006, the content of which is hereby incorporated by reference into this application.

### BACKGROUND OF THE INVENTION

The present invention relates to a method for calculating a community value and a community value calculation system, and more specifically to a method for calculating a community value and a community value calculation system which are suitable for an application to nurture communities in a regional society and to contribute to enhance social capital.

When a new approach is being implemented in a region, accumulated connections and trusting relationships among people in the region will enable smooth startup of the approach and promote sustainability of the approach after the startup. There are some explanations on the reason for causing the phenomena, one of which would be that the connections and trusting relationships among people reduce transaction costs related to communications among related persons. Therefore, such connections and trusting relationships among people can be deemed as one single asset and they are sometimes referred to as “social capital” collectively. There are some methods for measuring the social capital (for example, Research Institute for Development and Finance of Japan Bank for International Cooperation: Cost-Benefit Analysis of Participatory Approach—Conceptual Review and Framework of Quantitative Analysis—, See JBICI Research Paper No. 21 (January 2003)). One of the methods is based on questionnaires, in which the social capital is measured through questionnaire surveys concerning existences of informal organizations within a region, participation frequencies of residents to the informal organizations, etc. Another one is to depict relationships of related persons with their acquaintances in a graph and quantify the graph structure based on a social network analysis, thereby analyzing the social capital. In addition, technologies described in the gazette of Japanese Patent Application Laid-open No. 2003-187052, and Takeaki Kariya: Brand Evaluation and Value Creation—Model Comparison and Application to Business Strategy, Nikkei Advertising Research Institute (November 2005) are also known.

### SUMMARY OF THE INVENTION

The analysis on the social capital stated above is not intended to evaluate a financial value of the social capital. On the other hand, intangible assets such as the social capital include brands concerning companies and commodities. There are some methods that evaluate a brand value financially from the viewpoint that how much cash flow will be produced by the brand (for example, see Patent Reference 1 and Non-patent Reference 2). Nevertheless, with respect to the social capital, financial evaluations have not been executed based on financial indices because no market exists to deal with the social capital itself The social capital is originally a medium to encourage approaches in a community. The value of the social capital, therefore, cannot be evaluated unless the social capital is considered in combination with the approaches for the social capital.

As stated above, since evaluations have not been made concerning the financial value of the social capital, there were problems that related companies hesitate to make investments or cannot have sufficient information to make a decision on appropriate implementation of public projects.

The present invention has been made to resolve the above-stated problems. It is, therefore, an object of the present invention to appropriately execute financial evaluations of the social capital in a community such as a regional society.

In a community value calculation system according to the present invention, profiles are created based on service attributes of services related to the social capital. Then, members in a regional society are requested to select one of the profiles before a questionnaire survey is executed concerning an actual community involvement status of the person.

Next, a social capital index is calculated based on the data collected in the survey, and the marginal willingness to pay (hereinafter referred to as “marginal WTP”) relative to each service attribute of services related to the social capital of the regional society is estimated.

To calculate a community value, a service attribute is first designated, and a difference between calculated marginal WTP values for some requested regional societies is evaluated as a financial value of the social capital.

### BRIEF DESCRIPTION OF THE DRAWINGS

FIG. 1 is a functional configuration diagram of a community value calculation system.

FIG. 2 is a hardware configuration diagram of the community value calculation system.

FIG. 3 is a flow chart illustrating processing steps of a questionnaire creation processing unit 102.

FIG. 4 shows an example of service attributes and attribute levels which are targeted for evaluating a community value.

FIG. 5 shows an example of an orthogonal table for creating a service profile.

FIG. 6 shows an example of service profiles.

FIG. 7 shows an example of questionnaire content for social capital evaluation.

FIG. 8 is a flow chart showing processing of a questionnaire analysis processing unit 103.

FIG. 9 is a flow chart showing processing of a social capital calculation processing unit 104.

FIG. 10 is a flow chart showing processing of marginal willingness to pay (WTP) estimation processing unit 105.

FIG. 11 is a diagram illustrating a display example of a screen on which a service attribute for calculating a community value is designated.

FIG. 12 is a flow chart illustrating processing of a community value calculation processing unit 106.

FIG. 13 shows a screen on which a calculated community value is displayed.

### DESCRIPTION OF THE PREFERRED EMBODIMENTS

In an embodiment of the present invention, a safety control service for elementary school students by using a compact portable terminal will be used as an example to evaluate a community value in the service. It should be noted that, in the present invention, the content of services may be arbitrary and the present invention is not limited to such an example of the service.

In the service, if an elementary school student comes across an emergency situation, an emergency signal is transmitted when the student presses an emergency button on a mobile terminal. Subsequent actions are divided into several levels, of which typical examples would include: a level that an emergency report is simply notified to his/her parents; a level that an emergency report is notified to a nearby volunteer and the volunteer who received the report goes to the site in a hurried manner; and a level that an emergency report is notified also to a security company and a security guard goes to the site in a hurried manner as well as a volunteer. In the case where the volunteer goes to the site in a hurried manner, cooperation among residents is important. If cooperation among residents on a daily basis is insufficient, for example, the volunteer will not be able to find who is a volunteer and who is a suspicious person. To enhance the value of this service, therefore, nurturing of a regional community will be one of important factors. In this embodiment, the financial evaluation (social benefit) of a community value will be executed in this service. As a result of the financial evaluation, local authorities can promote measures for nurturing volunteers, and information to make a decision on appropriate investments can be provided to the security company.

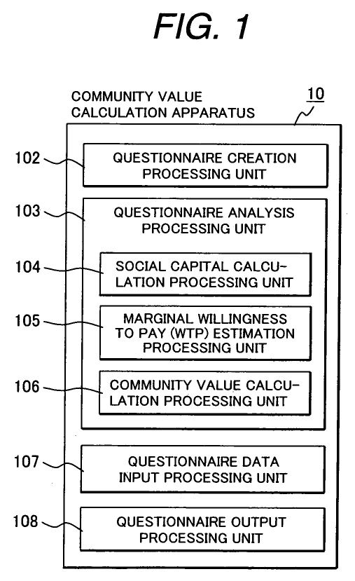

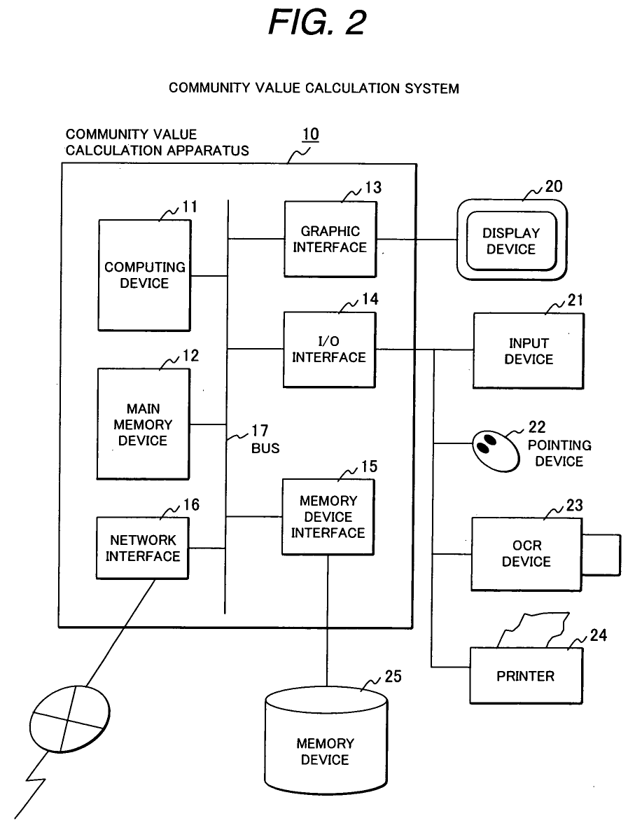

The embodiment will be described with reference to FIGS. 1 to 13. First, the configuration of a community value calculation system will be described with reference to FIGS. 1 and 2. FIG. 1 is a functional configuration diagram of the community value calculation system. FIG. 2 is a hardware configuration diagram of the community value calculation system.

The hardware configuration diagram of the community value calculation system comprises a community value calculation apparatus 10, a display device 20, an input device 21, a pointing device 22, an OCR device 23, a printer 24 and a memory device 25.

The community value calculation apparatus 10, while being connected with other peripheral devices, plays a central role in the system. A computing device 11, a main memory device 12, a graphic interface 13, an I/O interface 14, a memory device interface 15 and a network interface 16 are connected to the community value calculation apparatus 10 via a bus 17.

A program for calculating a community value is stored in a memory device 25 and is executed by the computing device 11 after loaded into the main memory device 12.

The display device 20 includes a liquid crystal display and a CRT device, etc. for displaying information concerning a community value and calculation results.

The input device 21 is, for example, a keyboard. The pointing device 22 includes, for example, a mouse and a trackball.

The OCR device 23 is a device to read results of questionnaires.

The printer 24 is a device to print out information concerning a community value and calculation results.

The memory device 25 is a large-capacity memory device such as a hard disk.

Further, the community value calculation apparatus 10 is connected to an external network such as a LAN or the Internet via the network interface 16.

The community value calculation system comprises a questionnaire creation processing unit 102, a questionnaire analysis processing unit 103, a questionnaire data input processing unit 107 and a questionnaire output processing unit 108, as functional units.

The questionnaire creation processing unit 102 is a unit for creating questionnaires for members in a regional society.

The questionnaire analysis processing unit 103 is a unit for analyzing the questionnaires answered by the members of the regional society for evaluation of the financial value of the social capital.

The questionnaire data input processing unit 107 is a unit for inputting the questionnaires answered by the members of the regional society. The questionnaire output processing unit 108 is a unit for outputting a format of the questionnaires answered by the members of the regional society.

Further, the questionnaire analysis processing unit 103 comprises a social capital calculation processing unit 104, a marginal willingness to pay (WTP) estimation processing unit 105 and a community value calculation processing unit 106.

The social capital calculation processing unit 104 is a unit for calculating social capital indices for each region. The marginal willingness to pay (WTP) estimation processing unit 105 is a unit for estimating marginal WTP for each service attribute. The community value calculation processing unit 106 is a unit for calculating a community value for each the service attributes.

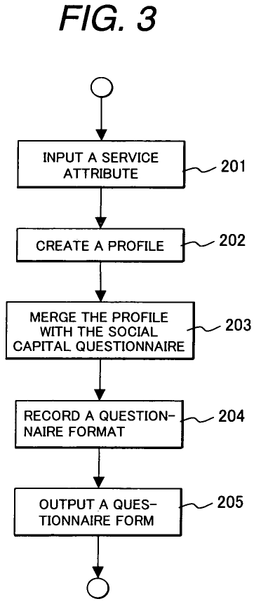

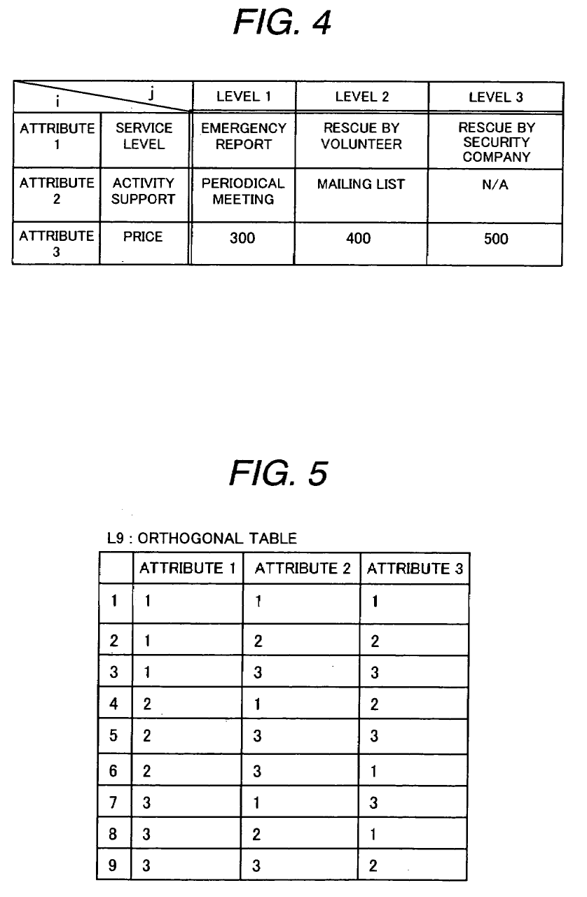

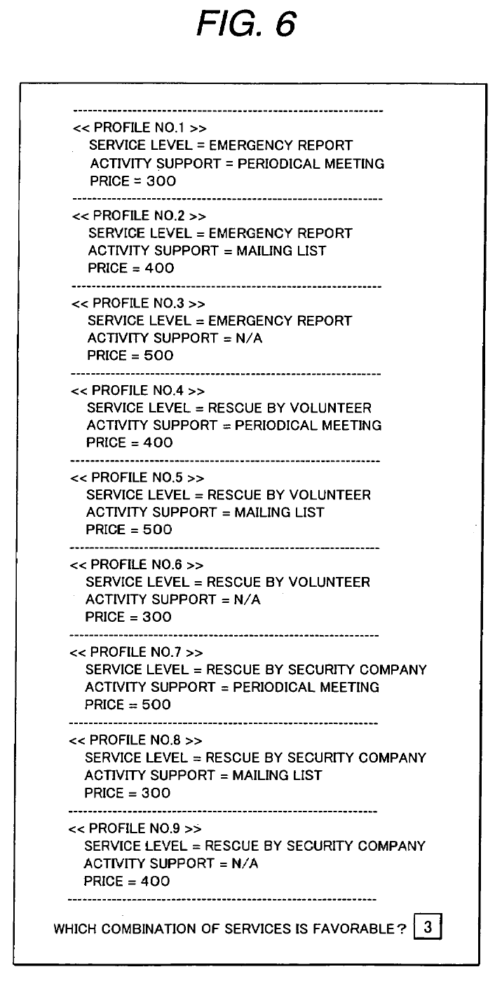

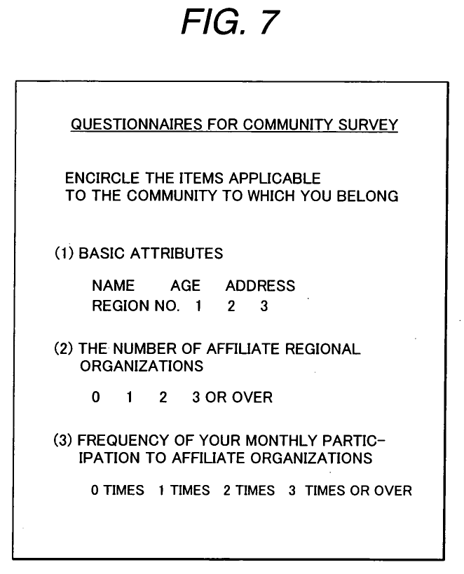

Processing steps of the questionnaire creation processing unit 102 will be described with reference to FIGS. 3 and 7. FIG. 3 is a flow chart illustrating the processing steps of the questionnaire creation processing unit 102. FIG. 4 is a diagram illustrating an example of service attributes and attribute levels associated with community values evaluated. FIG. 5 shows an example of an orthogonal table for creating a service profile. FIG. 6 shows an example of service profiles. FIG. 7 shows an example of questionnaire content for social capital evaluation.

First, service attributes {Ai} of a public service and levels [Bij] of each service are input from an input device 111 (Step 201).

Service attributes in the embodiment are: A1=service level; A2=activity support; and A3=price, as shown in FIG. 4. Further, the levels of each service attribute are: B11=emergency report to parents; B12=rescue by volunteer; B13=rescue by security company; B21=periodical meeting; B22=mailing list; B23=N/A; B31=300 yen; B32=400 yen; and B23=500 yen.

Here, the term “activity support” means approaches for supporting cooperation among residents of the region. That is, it means activities that contribute to formation of communities in the region. The term “periodical meeting” means that opportunities for periodically exchanging information, for example, once a month, with attendance of volunteers involved in the service, which are provided by the local authority, etc. The term “mailing list” means that a mailing list of volunteers in the service is created and information exchange is conducted on a routine basis. It should be noted that the mailing list is a system in which information on a given subject is exchanged among given users by using electronic mails.

Next, based on the service attributes {A1} and levels {Bij} of each service input in Step 201, service profiles {Pk} are generated by using an orthogonal design method (Step 202). With respect to the service attributes and the levels shown in FIG. 4, for example, nine profiles in total that are shown in FIG. 6 will be created based on an orthogonal table L9 shown in FIG. 5.

Next, questionnaire items for a social capital survey are merged into the service profiles {Pk} which are created in Step 202 and a questionnaire format is completed (Step 203). The questionnaire format is stored in the memory device 25 (Step 204). It should be noted that, in the embodiment, items shown in FIG. 7 is assumed as examples of the questionnaire items for the social capital survey. As is obvious, the items will not be limited to items that are shown in FIG. 6 so far as the contents of the items are intended to evaluate the social capital.

Next, the questionnaire output processing unit 108 prints out the questionnaire format that is stored in Step 204 by using the printer 24 (Step 205).

Thereafter, based on the questionnaire form printed out, a questionnaire survey will be carried out for residents of a region. Here, for the portion of service profiles in the questionnaires, one of the service profiles suitable for the region is selected by residents of the region, as shown in FIG. 6. Then, after the questionnaire survey, the community value is calculated based on the questionnaire data collected. In the embodiment, the questionnaire form is utilized for implementing out the questionnaire survey. However, the survey may be implemented on the Internet by using the WWW (World Wide Web) based on the questionnaire format stored in the memory device 25 in Step 203.

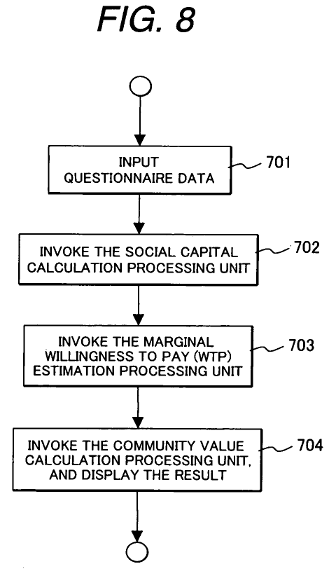

Next, the processing of the questionnaire analysis processing unit 103 will be described with reference to FIG. 8. FIG. 8 is a flow chart illustrating the processing of the questionnaire analysis processing unit 103.

The processing for calculating the community value is executed by the questionnaire analysis processing unit 103.

First, the questionnaire data input processing unit 107 reads questionnaire data from the questionnaire forms collected via the OCR device 109, and input it to the memory device 25 (Step 701).

Next, based on the questionnaire data stored in Step 701, the social capital calculation processing unit 104 for calculating social capital indices for each region is invoked (Step 702).

Next, based on the questionnaire data stored in Step 701 and the social capital indices for each region calculated in Step 702, the marginal willingness to pay (WTP) estimation processing unit 105 for estimating the marginal WTP for each service attribute is invoked (Step 703).

Next, based on the marginal WTP for each service attribute calculated in Step 703, the community value calculation processing unit 106 for calculating the community value for each service attribute is invoked, and the community value for each service attribute which is calculated are displayed on the display device 110 (Step 704).

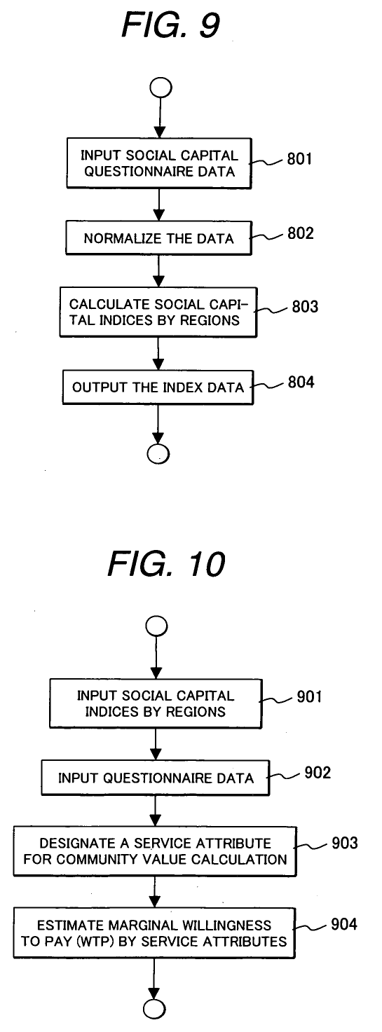

Next, the processing of the social capital calculation processing unit 104 will be described with reference of FIG. 9. FIG. 9 is a flow chart illustrating the processing of the social capital calculation processing unit 104.

The social capital calculation processing unit 104 is invoked in Step 702 shown in FIG. 8.

First, among the questionnaire data that is read in the above Step 701, questionnaire data related to the social capital is input to the social capital calculation processing unit 104 (Step 801).

Next, data of each questionnaire item of the questionnaire data concerning the social capital which is read in Step 802 is normalized (Step 802).

In the embodiment, the normalization is executed in the following steps.

It is assumed that the first questionnaire item of the questionnaire data concerning social capital has N₁ categories, data k (1<k<=N₁) is rescaled to 0 to 100 by using the (Equation 1) shown below.

V_{Q}=(100/N_{Q})×k−100/(N_{Q}×2) (Equation 1)

Next, for each data of questionnaire items that are normalized in Step 802, the average value M₁ₚ (1=l to m: m is the number of questionnaire items) of a community p is calculated by using the (Equation 2) shown below.

$${M}_{lp} = \frac{1}{\vert {R}_{p} \vert} {\sum }_{n ∈ {R}_{p}} {V}_{ln} \qquad ( Equation 2 )$$

### |Rₚ|: The number of persons who answered the questionnaires in the region p.

Here, p is a region number and Rₚ is a set of persons who live in the region of the region number p and answered the questionnaires. Further, V₁ₙ is data that is rescaled by using the (Equation 1) for the n-number of persons.

Next, an average value of M₁ₚ for each region p is calculated, and is defined as the social capital index SCₚ by using the (Equation 3) shown below.

$$S {C}_{p} = {\sum }_{l} {M}_{lp} \qquad ( Equation 3 )$$

Finally, the social capital indices SCₚ for each region that are calculated in Step 803 are recorded in the memory device 25 (Step 804).

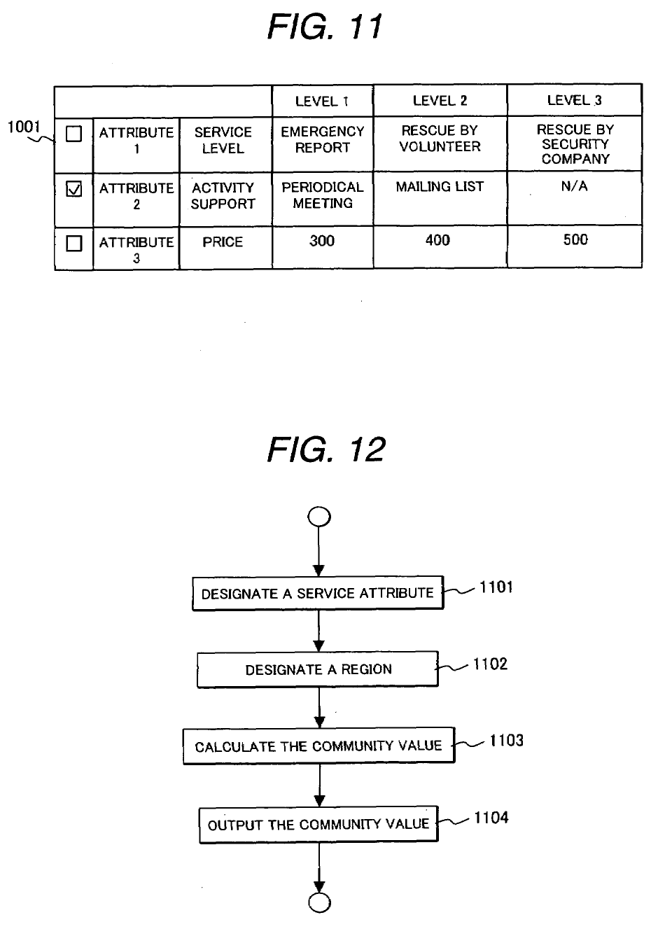

Next, the processing of marginal willingness to pay (WTP) estimation processing unit 105 will be described with reference to FIG. 10 and FIG. 11.

FIG. 10 is a flow chart illustrating the processing of marginal willingness to pay (WTP) estimation processing unit 105.

FIG. 11 is a diagram illustrating a display example of a screen on which a service attribute for calculating a community value is designated.

First, the social capital indices for each region which are calculated by the social capital calculation processing unit 104 and are stored in the memory device 25 are input to the marginal willingness to pay (WTP) estimation processing unit 105 (Step 901).

Next, the questionnaire data that is stored in the memory device 25 in Step 701 in FIG. 8 is input to the marginal willingness to pay (WTP) estimation processing unit 105 (Step 902).

Next, service attributes corresponding to the community value evaluated are designated from the screen shown in FIG. 11 via the pointing device 114. In the embodiment, the activity support is selected as the service attribute related to the community value (Step 903).

Thereafter, the marginal WTP for each service attribute is calculated as shown below (Step 904).

Here, the term “marginal WTP” is variation in willingness to pay caused by changing a service attribute, and willingness to pay is the amount of payment that is allowable for the individual to a service.

The utility level vᵢⱼ for the case that an individual i selects a profile j is defined by the following (Equation 4). The term “utility level” is an evaluation quantity of benefit which is felt by the individual to the service.

$${v}_{ij} = {β}_{o} + {\sum }_{k} {β}_{k} {χ}_{jk} + {β}_{m} {χ}_{jm} + {ɛ}_{ij} \qquad ( Equation 4 )$$

Here, xⱼₖ and xⱼₘ are attributes that configure a profile, and in particular, xⱼₘ is an attribute related to financial evaluation among attributes. Further, concerning the parameter βₖ of xⱼₖ which is designated as an attribute for calculating the community value in Step 903, βₖ is expressed as a decreasing function of SCₚ, for example, in a Weibull function which is shown by the (Equation 5) below. Note that, however, SCₚ(i) is a social capital index for the individual i.

βₖ=exp(−exp(Iₙ(SCₚ(i))))γk (Equation 5)

Here, the random utility theory and eᵢⱼ are assumed to be the Gumbel distribution, probability Pij that the individual i will select the profile j is expressed by the (Equation 6) below.

$${P}_{ij} = exp ( {v}_{ij} ) / {\sum }_{j} exp ( {v}_{ij} ) \qquad ( Equation 6 )$$

Following the above, the marginal WTP can be expressed by the (Equation 7) below.

$$\frac{d {χ}_{jm}}{d {χ}_{jk}} = - \frac{{β}_{k}}{{β}_{m}} \qquad ( Equation 7 )$$

To estimate the parameter βₖ of the (Equation 4), a log likelihood function is set by using the (Equation 8) below to execute estimation with a maximum-likelihood estimation method, such as the Newton-Raphson method. More specifically, a combination of β₀, βₖ and βₘ which maximizes the logL is calculated.

$$\begin{matrix}{L}_{og} L = {\sum }_{i , j} {d}_{ij} {l}_{n} ( {P}_{ij} ) \\ = {\sum }_{i , j} {d}_{ij} {l}_{n} ( exp ( {v}_{ij} ) / {\sum }_{j} exp ( {v}_{ij} ) )\end{matrix} \qquad ( Equation 8 )$$

Here, L=ΠdᵢⱼPᵢⱼ, and dᵢⱼ indicates a dummy variable which becomes 1 when the individual i selects the profile j.

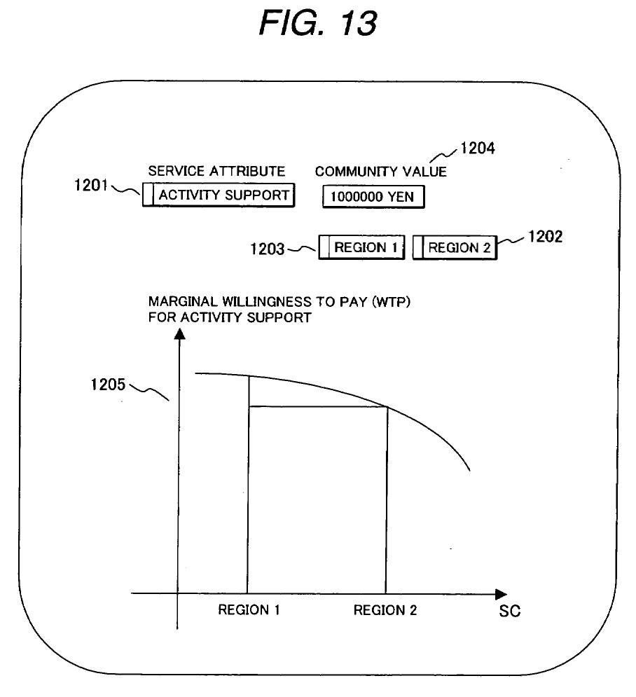

Next, the processing of the community value calculation processing unit 106 will be described with reference to FIG. 12 and FIG. 13. FIG. 12 is a flow chart illustrating the processing of the community value calculation processing unit 106. FIG. 13 is a diagram illustrating a screen on which a calculated community value is displayed.

The community value calculation processing unit 106 is invoked in Step 704 in FIG. 8 to calculate community values for each service attribute.

First, from a pull-down menu 1201 on the screen shown in FIG. 13, a service attribute corresponding to the community value evaluated is designated by using the pointing device 114 (Step 1101). In this embodiment, the community value only for the activity support is calculated.

Next, from pull-down menus 1202 and 1203 for designating regions on the screen shown in FIG. 13, two regions are designated by using the pointing device 114 (Step 1102). Here, a graph 1205 shows the relationship between the social capital values of the two regions and marginal WTP for the service attribute designated in Step 1101. To designate two regions, it is desirable to reference the graph 1205.

Next, with respect to the service attribute designated in Step 1102, the difference between the marginal WTP values of the two regions designated in Step 1102 is calculated (Step 1103). The difference should be the community value of the service attribute concerned. Here, for calculation of the difference, the smaller marginal WTP is subtracted from the larger one.

Thereafter, the community value calculated in Step 1103 is output to a community value display unit 124 (Step 1104).

When introducing an IT service like a community information service, an appropriate IT investment becomes possible by defining the community value of the region and benefits of the IT service. It should be noted that, in the embodiment, description was made of regional communities and regional services. However, in terms of communities, an application to company organizations may be considered. In this case, it will be possible to evaluate communication services such as blogs and electronic bulletin boards within a company as well as community values within the company organizations.

With respect to the present invention, it is possible to appropriately execute financial evaluations of social capital in a community such as regional societies.

What is claimed is:

1. A community value calculation method for calculating a community value by executing financial evaluations of social capital of services for a plurality of groups in a community using a computer system, the method comprising the steps of:
inputting information to evaluate service attributes of the services for the plurality of groups in the community and information on members of the plurality of groups in the community;
designating one of the service attributes of the services in the community; and
computing social capital indices of the plurality of groups based on the input information on the members of the plurality of groups in the community;
wherein
willingness to pay (WTP) of the members of the plurality of groups relative to the designated service attribute is estimated based on the social capital indices computed and the information to evaluate service attributes of the services for the members of the plurality of groups in the community.

2. A community value calculation method according to claim 1, wherein
a financial evaluation on social capital relative to the designated service attribute is executed by calculating a difference between the WTP of members of a first group relative to the designated service attribute and the WTP of members of a second group relative to the designated service attribute.

3. A community value calculation method for calculating a community value by executing financial evaluations of social capital of services for a plurality of groups in a community using a computer system, the method comprising the steps of:
(1) inputting information to evaluate service attributes of services for members of first and second groups in the community and information on members of the groups in the community;
(2) designating one of the service attributes of services in the community;
(3) calculating respective social capital indices of the first and the second groups based on the input information on members of respective groups in the community;
(4) estimating marginal willingness to pay (WTP) of the members of the first group relative to the designated service attribute and marginal willingness to pay (WTP) of the members of the second group relative to the designated service attribute based on the computed social capital indices and the input information to evaluate the service attributes of the services for members of the groups in the community; and
(5) calculating a difference between marginal WTP of members of the first group relative to the designated service attribute and the marginal WTP of members of the second group relative to the designated service attributes;
wherein
a financial evaluation on social capital relative to the designated service attribute is executed based on marginal WTP of members of the first group and the marginal WTP of members of the second group relative to the designated service attribute.

4. A community value calculation method according to claim 3, wherein
a decreasing function of the social capital indices is used in the step (5).

5. A community value calculation method according to claim 4, wherein
a Weibull function is used for the decreasing function.

6. A community value calculation method according to claim 1, wherein
information to evaluate the service attributes of the services for the members of the groups in the community includes questionnaire data that contains questionnaire items related to the service attributes, levels, and WTP concerning the services in the community.

7. A community value calculation method according to claim 6, the method further comprising the steps of:
creating a questionnaire format of the questionnaire data that contains the questionnaire items related to the service attributes, the levels, and the WTP concerning the services in the community; and
inputting questionnaire data included in the questionnaire format.

8. A community value calculation system that includes an input device, an output device, a memory device and a computing device, and executes financial evaluations of social capital of services for a plurality of groups in a community, the system comprising the steps of:
inputting information to evaluate service attributes of the services for members of the plurality of groups in the community and information on the members of the plurality of groups in the community from the input device;
designating one of the service attributes related to social capital;
storing the input information to evaluate the service attributes of the services for the members of the groups in the community and the input information on the members of the groups in the community in the memory device;
computing social capital indices of each group based on the input information on the members of the groups in the community by the computing device; and
estimating WTP of the members of each group relative to the designated service attribute based on the computed social capital indices and the input information to evaluate the service attributes of the services for the members of the groups in the community;
calculating a difference between WTP of members of a group relative to the designated service attribute and WTP of members of another group relative to the designated service attribute by using the computing device; and
outputting financial evaluation on social capital relative to the designated service attribute by using the computing device.
